(19) United States
(12) Patent Application Publication
(10) Pub. No.: US 2013/0103934 A1
(43) Pub. Date: Apr. 25, 2013

(54) COMPUTER SYSTEM AND METHOD FOR TAKING OVER MODULE THEREIN

(71) Applicant: HITACHI, LTD., Tokyo (JP)

(72) Inventors: Daichi Hashioka, Hadano (JP); Takuhiro Kawaji, Hadano (JP); Takayuki Abe, Hadano (JP); Yoshiaki Miyazaki, Hadano (JP)

(73) Assignee: HITACHI, LTD., Tokyo (JP)

(21) Appl. No.: 13/651,865

(22) Filed: Oct. 15, 2012

(30) Foreign Application Priority Data
Oct. 21, 2011 (JP) 2011-231259

(51) Int. Cl. G06F 15/177

(52) U.S. Cl. 713/1

(57) ABSTRACT

In a computer system comprising an active computer and a standby computer, when an active computer stopped due to occurrence of a failure is switched over to a standby computer, the standby computer cannot access to a TPM in the stopped active computer if the TPM is mounted therein, and therefore, the standby computer cannot take over the TPM in use from the active computer. The present invention provides a computer system comprising a TPM provided outside an active computer, to enable takeover of a TPM in use from an active computer to a standby computer when performing a switchover therebetween.

### TECHNICAL FIELD

The present invention relates to a computer system and a method for taking over a module therein.

As a background art in the field of the invention, there is Japanese Unexamined Patent Application Publication No. 2007-094611 (hereinafter, referred to as Patent Document 1). Patent Document 1 describes “When a computer is switched over to another computer in a redundant computer system configured to boot from a storage area network (SAN), a software image of an active computer cannot be taken over by a standby computer as is since unique IDs (World Wide Name) allocated to respective fiber channel ports of the active computer and the standby computer are different from each other. To solve this problem, when an active computer is switched over to a standby computer, a management server distributes an information collection and configuration program to the standby computer before activating a user operating system of the standby computer. Thereafter, software of the information collection and configuration program allocates a unique ID (World Wide Name) allocated to a fiber channel port of the active computer to a fiber channel port of the standby computer so as to enable the standby computer to take over a software image of the active computer as is.”

Further, there is also Japanese Unexamined Patent Application Publication No. 2004-282391 (hereinafter referred to as Patent Document 2). Patent Document 2 discloses an information processing device comprising a mother board in which TPM (Trusted Platform Module) being a hardware device giving the usage right is mountable. The information processing device includes a TPM configured to hold an encryption key and a decryption key, the keys being asymmetric to each other, as a pair of data; an encryption data receiving unit configured to receive initial data encrypted in the TPM by using the encryption key; a data decryption unit configured to decrypt initial data encrypted in TPM by using the decryption key; and a decryption result determining unit configured to determine whether or not decrypted initial data is identical with the initial data. When the decryption result determining unit determines that both initial data is not identical with each other, the information processing device determines that there exists no usage right.

### SUMMARY

Patent Document 1 describes a computer system and a method for the booting control thereof. In the computer system disclosed in Patent Document 1, however, there is no reference to the takeover of the TPM when performing a switchover from an active computer to a standby computer.

In a computer system comprising active computers and a standby computer, when an active computer stopped due to occurrence of a failure is switched over to a standby computer, the standby computer cannot access to TPM in the stopped active computer if the TPM is mounted therein, and therefore, the standby computer cannot take over the TPM in use from the active computer.

In view of the above problem, the present invention provides a computer system comprising a TPM provided outside an active computer, to enable takeover of a TPM in use from an active computer to a standby computer when performing a switchover therebetween.

To address the above problem, for example, a configuration according to one aspect of the present invention is adopted.

Amongst multiple means provided by the present invention to solve the above problem, one aspect of the present invention provides a computer system including a plurality of computers; a storage unit configured to store information of the plurality of computers; a trusted platform module (hereinafter referred to as TPM) comprising encryption means configured to encrypt information of the storage unit; a TPM switch configured to connect the plurality of computers and the TPMs to one another; connection management information configured to manage the association between the plurality of computers and the TPMs in the connection; and a management server configured to manage the plurality of computers. The management server, upon detecting that a first computer is stopped due to occurrence of a failure, rewrites an identifier of a TPM associated with a second computer to an identifier of a TPM associated with the stopped first computer, in the connection management information. The TPM switch, based on the rewritten connection management information, connects the TPM associated with the stopped first computer and the second computer to each other. The second computer, by using the TPM associated with the stopped first computer, accesses to a storage unit in which a booting OS of the stopped first computer is stored, and takes over and activates the booting OS of the stopped first computer.

The present invention provides a computer system capable of taking over a TPM in use even when a switchover from an active computer to a standby computer takes place.

The above problem, configuration and effect will become apparent in the following description of embodiments of the present invention.

### BRIEF DESCRIPTION OF THE DRAWINGS

FIG. 1 is a configuration diagram showing a redundant system for illustrating an embodiment of the present invention;

FIG. 2A shows a connection management table of a management server;

FIG. 2B shows a path table of a TPM switch;

FIG. 3 is a flowchart showing a start-up operation of a computer system;

FIG. 4 is a flowchart showing a switchover operation between computers;

FIG. 5 is a system configuration diagram during a switchover between computers;

FIG. 6 is an example of updating the connection management table in a switchover operation between computers; and

FIG. 7 is a system configuration diagram in a switchover operation between computers involving a TPM switchover.

### DETAILED DESCRIPTION

Hereinafter, embodiments of the present invention are described with reference to the accompanying drawings.

A computer system including an active computer and a standby computer according to the present invention is described in detail with reference to the accompanying drawings, wherein a trusted platform module (hereinafter referred to as TPM) is provided outside the computers, and a TPM in use can be taken over from an active computer to a standby computer when performing a switchover therebetween.

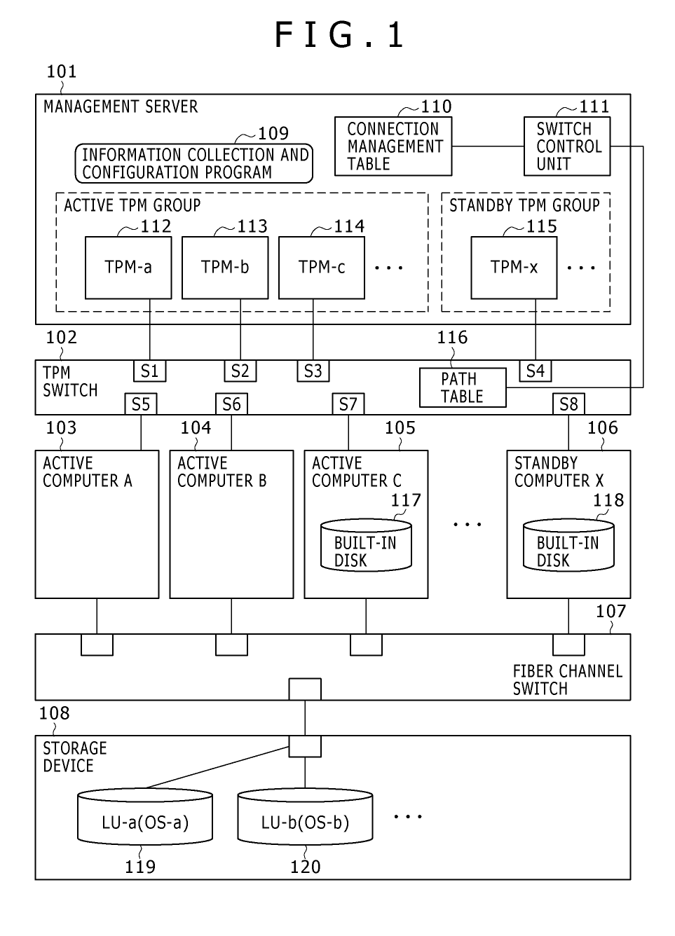

FIG. 1 is a configuration diagram showing a redundant configuration of a computer system using a SAN (Storage Area Network) booting environment and TPMs according to the present embodiment.

A management server 101 manages computers 103 to 106. The management server includes an information collection and configuration program 109, a connection management table 110, a switch control unit 111, a TPM-a 112, a TPM-b 113, a TPM-c 114, and a TPM-x 115.

Information (data) of computers is stored in storage units (disks). Hereinafter, the storage units in the present embodiment refer to built-in disks 117 and 118 each included in computers 105 and 106, or logical units 119 and 120 in an external storage device (hereinafter referred to as a storage device) 108.

TPMs 112 to 115 include encryption means configured to encrypt information in the storage unit. Hereinafter, each of TPMs 112 to 115 in the present embodiment comprises, as encryption means, an encryption key storage unit configured to store an encryption key necessary to encrypt information in the storage unit. Encryption keys in TPMs 112 to 115 are used by computers to encrypt information stored in the storage unit. Further, TPMs 112 to 115 include a decryption key storage unit configured to store a decryption key necessary to decrypt data encrypted with the encryption key. To refer to data encrypted by using an encryption key stored in a TPM, it is necessary to decrypt data by using a decryption key stored in the same TPM used for encryption.

The management server 101 is a server provided with functions of managing device information, configuring the booting OS, and distributing software such as applications to an active computer A 103, an active computer B 104, an active computer C 105, and a standby computer X 106. The management server 101 may be a service processor provided with the above functions.

The management server 101 distributes the information collection and configuration program 109 to the active computer A 103, the active computer B 104, the active computer C 105 and the standby computer X 106 before activating the OS of the computers, to collect device information and configure a disk used for booting the OS.

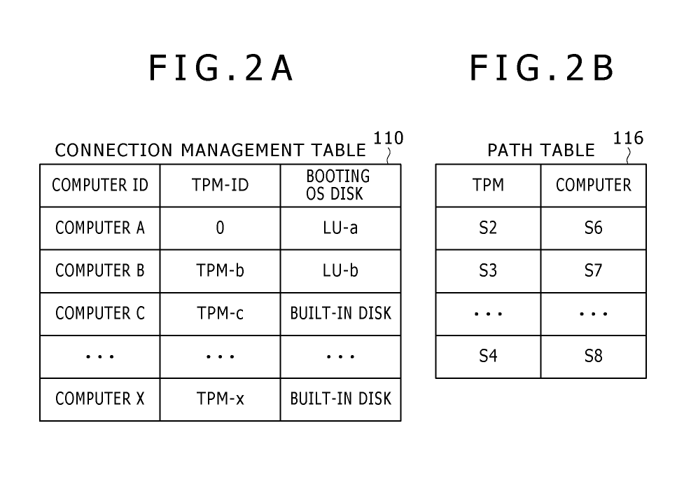

The connection management information includes path information associating a computer with information of a disk used for booting the OS thereof. Hereinafter, the connection management information in the present embodiment refers to the connection management table 110. Disk configuration will be described later with reference to FIG. 2A.

A TPM switch 102 is configured to connect computers 103 to 106 and TPMs 112 to 115 to one another. The TPM switch 102 includes upstream ports S1, S2, S3, and S4 connected to the TPMs, downstream ports S5, S6, S7, and S8 connected to the computers, and path information managing the connection association between the upstream ports and the downstream ports. Hereinafter, the path information in the present embodiment refers to the path table 116.

The TPM switch 102 controls the electric communication path between computers 103 to 106 and TPMs 112 to 115 by referring to the path table 116. The switch control unit 111 updates values of the path table 116 so as to configure a logical connection state registered in the connection management table 110. The path table 116 will be described later with reference to FIG. 2B.

The active computer A 103, the active computer B 104, the active computer C 105, and the standby computer X 106 are connected respectively to a TPM-a 112, a TPM-b 113, a TPM-c 114, and a TPM-x 115, via the TPM switch 102.

The active computer A 103, the active computer B 104, the active computer C 105, and the standby computer X 106 are connected respectively to the storage device 108 via the fiber channel switch 107.

The storage device 108 includes only a predetermined number of logical units (LUs) as a storage region. LUs according to the present embodiment store OS-a 119 and OS-b 120, each of which represents a booting OS for the active compute A 103 and the active computer B 104. Information stored in the LUs is not limited to the booting OS, but may be data for reference of the OS.

A booting OS for the active computer C 105 is stored in a built-in disk 117.

The standby computer X 106 comprises a built-in disk 118 and is capable of taking over an ongoing processing from any one of the active computer A 103, the active computer B 104, and the active computer C 105, whichever is stopped

Even with a computer system of such a configuration, there may occur a situation where a standby computer should not take over and not use a TPM used by an active computer due to a nature of the TPM during a switchover between the computers. For example, when a disk used by an active computer to activate an operating system (OS) thereof is a disk mounted in the active computer, the TPM should not be taken over, since the disk used to activate the OS also cannot be referenced to when the active computer is stopped.

FIG. 2A shows the connection management table 110 and, Fib. 2B shows the path table 116.

The connection management table 110 is configured to manage the association between computers 103 to 106 and TMPs 112 to 115 when being connected via the TPM switch 102. The computer ID in the connection management table 110 represents a unique ID allocated to a computer. The TPM ID in the connection management table 110 represents an identifier of a TPM which is connected to the computer. The booting OS Disk in the connection management table 110 indicates that a disk used for booting the OS of the computer is a built-in disk or either of logical units (LUs) in the storage device 108. The connection management table 110 associates the computer, the TPM, and the disk to one another.

The path table 116 indicates the connection state between a TPM and a computer. In the present embodiment, the association between computers and TPMs configured in the connection management table 110 is reflected on the path table 116 by associating upstream ports S2 to S4 and downstream ports S6 to S8 to one another as shown in FIG. 2B. The TPM switch 102 connects upstream ports S2 to S4 and downstream ports S6 to S8 to one another in accordance with the path table 116.

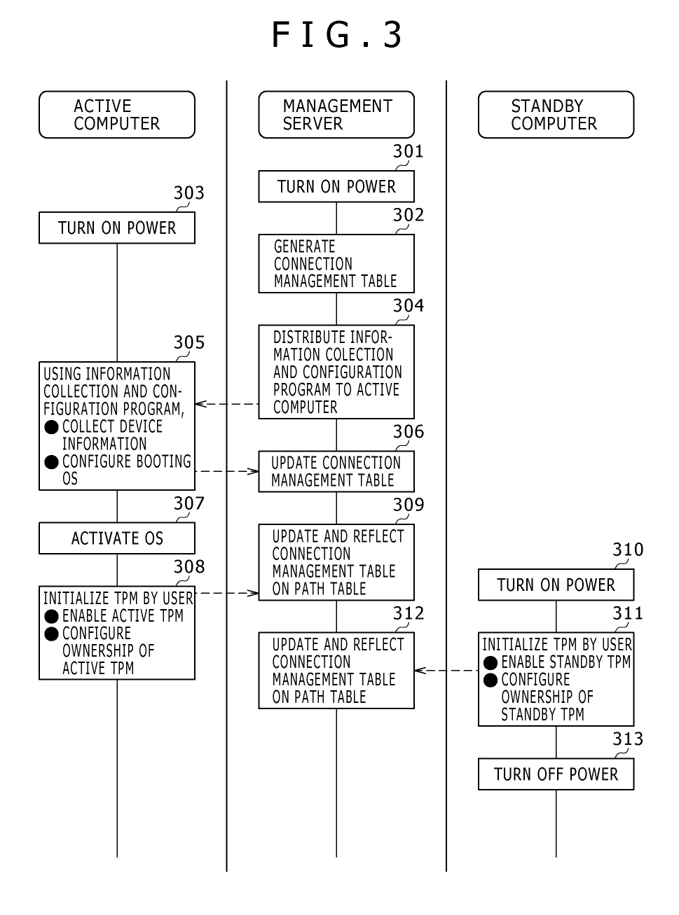

FIG. 3 is a flowchart showing a configuration operation of the connection management table when the computer system starts.

The management server 101, when power is turned ON (301), generates the connection management table 110 (302). Generally, predetermined initial values are configured in a just generated connection management table 110.

After an active computer has been powered ON (303), the management server 101 distributes the information collection and configuration program 109 to the active computer (304).

The active computer collects and configures the priority of the OS booting and the disk configuration information for OS booting, and notifies such information to the management server 101 (305). Based on the notified information, the management server 101 updates the value of the booting OS Disk in the connection management table 110 (306).

After processing of the information collection and configuration has been completed, the active computer activates the OS (307). For an active computer using a TPM, the user initializes a TPM in use via the active computer (308). Initialization of the TPM must be done by the user by physically accessing to the computer. Initialization of the TPM includes enabling of the TPM and configuring of the ownership of the TPM. The ownership of the TPM belongs to the user who knows the OS or the ownership key. The initialized TPM can be used only by the OS or the user holding the ownership, since any access without the ownership is not accepted.

When the TPM is initialized, the active computer notifies a TPM ID used thereby to the management server. The management server 101, based on the notified information, updates the value of the TPM ID in the connection management table 110, and reflects the value on the path table (309) so as to configure a logical connection between the computer and the TPM.

In order to enable the standby computer X 106 to continuously use a TPM even after the switchover of computers, when the standby computer X 106 is powered ON (310), the TPM used by the standby computer X 106 is initialized in a same manner as above (311). The management server 101, based on the initialization information, updates and reflects the connection management table 110 on the path table 116 (312). Thereafter, the standby computer X 106 is powered OFF (313) and put in a standby mode. Here, the TMP initialized by the standby computer X 106 is, for example, a standby TPM-x 115.

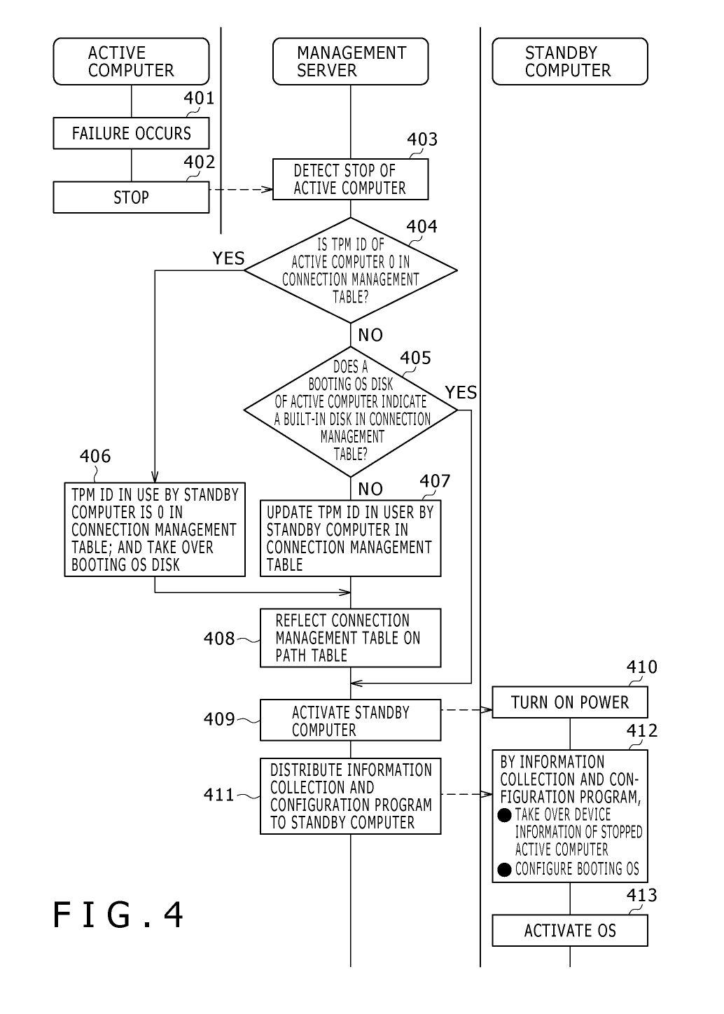

FIG. 4 is a flowchart for illustrating how the connection management table is configured and how the booting OS is switched over, when a switchover between computers takes place.

When any active computer is stopped (402) due to occurrence of a failure (401), the management server 101 detects the stop of the active computer (403). Any known method including a method for detecting the stop of a heartbeat signal may be applied as a method with which the management server detects a failure of an active computer, and the detection method used in the present embodiment is not limited.

Before switching an active computer to the standby computer X 106, the management server 101 refers to the connection management table 110 to determine which processing should be done. First, the management server 101 determines whether or not the TPM ID of the stopped active computer is 0 (404).

In the present embodiment, the TPM ID of 0 represents that the computer uses no TPM. When the TPM ID of the stopped active computer is 0, the management server 101 rewrites the entry of a TPM ID associated with the standby computer X 106 in the connection management table 110 to 0 such that the standby computer X 106 also takes over the configuration of not using the TPM. Further, the management server 101, in the connection management table 110, rewrites the entry of a booting OS Disk associated with the standby computer X 106 to a value of the entry associated with the stopped active computer. For example, if the stopped active computer was using an LU in the storage device 108 as a booting OS Disk, the standby computer X 106 takes over the LU.

Whenever a rewriting of the connection management table 110 occurs, the switch control unit 111 reflects any change in the connection management table 110 on the path table 116 (408). For example, the switch control unit 111, in the path table 116, rewrites an identifier of an upstream port connected to a TPM associated with the standby computer X 106 to an identifier of an upstream port connected to a TPM associated with the stopped active computer.

When the TPM ID of the active computer is not 0 (404), the management server 101 determines by referring to the connection management table 110 whether or not the booting OS Disk of the stopped active computer is a built-in disk (405).

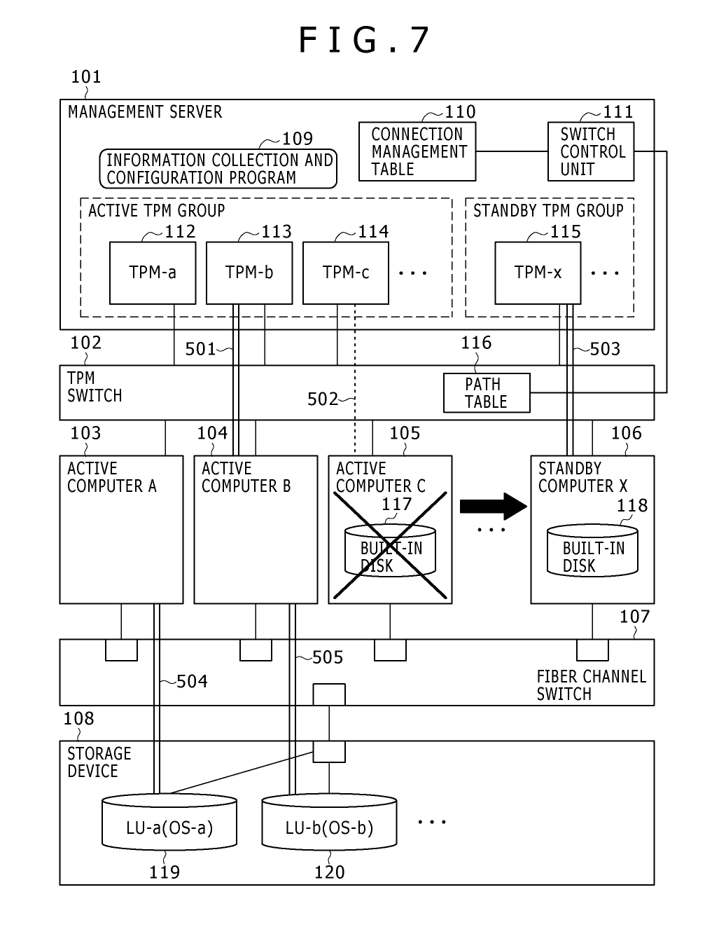

When the booting OS Disk of the active computer is a built-in disk (405), the management server 101 activates the standby computer X 106 without updating the connection management table 110 (409). This is because a standby TPM-x 115 is previously connected to the standby computer X 106 in the present embodiment. A standard computer cannot access to a built-in disk when a computer having a booting OS Disk in the built-in disk is stopped. The ownership of a TPM previously used by the active computer is held by a booting OS of the active computer. Therefore, in the present embodiment in which a TPM is used by a switched computer as well, it is necessary to previously finish the initialization of another TPM, i.e. TPM-x 115, by connecting the TPM to the standby computer X 106. Hereinafter, details of the processing will be described with reference to FIG. 7.

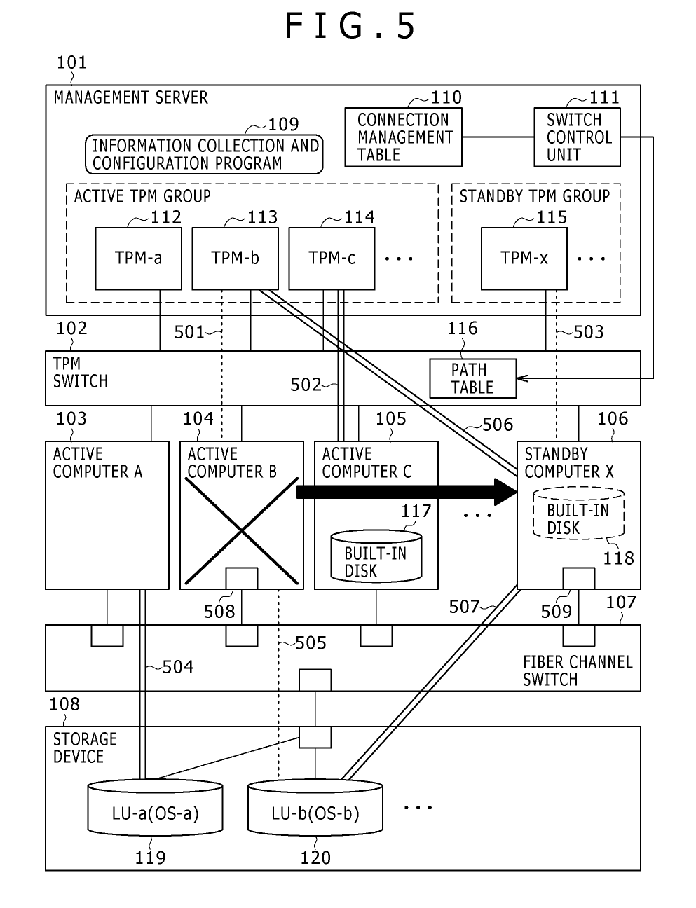

When the booting OS Disk of the active computer is an LU in the storage device but not a built-in disk (405), the booting OS can be taken over and used by the standby computer X 106, so that a TPM in use can be taken over as well. Accordingly, the management server 101, in the connection management table 110, rewrites a TPM ID associated with the standby computer X 106 to a TPM ID of the TPM used by the stopped active computer (407), and reflects the rewritten TPM ID on the path table 116 (408). Hereinafter, details of the processing will be described with reference to FIG. 5.

Next, the management server 101 activates the standby computer X 106 (409) and further distributes the information collection and configuration program 109 thereto (411).

By using the information collection and configuration program 109, the priority of OS booting and the disk for OS booting are configured in the standby computer X 106 in accordance with information of the connection management table 110 (412). With this configuration, the standby computer X 106, by using a TPM associated with the stopped active computer, accesses to a storage unit in which a booting OS of the stopped active computer is stored, and takes over and activates the booting OS of the stopped active computer.

Upon completion of the configuration processing, the booting OS is activated from a disk configured in the entry of the booting OS Disk (413).

FIG. 5 is a configuration diagram showing a specific computer switchover operation of an active computer which uses an LU in the storage device for access to the booting OS, as an aspect of the computer switchover in the computer system according to the present embodiment.

In the computer system shown in FIG. 5, configurations designated by like reference numerals and units having like functions shown in FIG. 1 are excluded from the description.

Configuration in the connection management table 110 shown in FIG. 2A is reflected on the path table 116 and the fiber channel switch 107 such that the active computer B 104 configures a logical connection 501 with a TPM-b 113 and a logical connection 505 with a LU-b 120.

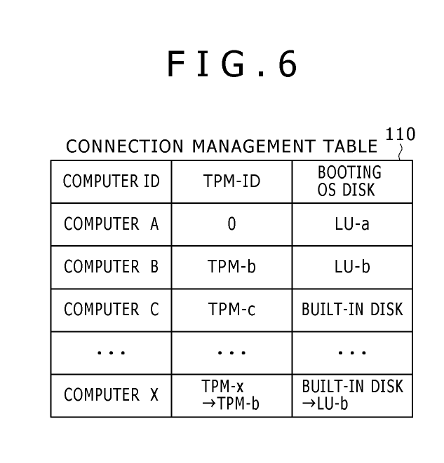

When the active computer B 104 is stopped due to occurrence of a failure, the management server 101 detects the stop and refers to the column “Computer B” in the connection management table 110. Since the connection management table 110 of FIG. 2A indicates that the TPM ID is TPM-b and the booting OS Disk is LU-b, the management server 101 determines that both the TPM and the booting OS disk can be taken over by the standby computer X 106 and rewrites configuration in the connection management table 110 as shown in FIG. 6. The switch control unit 111 translates and reflects the connection management table 110 on the path table 116, whereby a logical connection 506 is configured between the standby computer X 106 and the TPM-b 113.

When taking over device information of the active computer B 104, the standby computer X 106, by using the information collection and configuration program 109, takes over a unique ID (World Wide Name) allocated to a fiber channel connection port 508 of the active computer B 104 and allocates the unique ID to a fiber channel connection port 509 of the standby computer X 106. With this configuration, a logical connection 505 between the computer B 104 and LU-b 120 is taken over by a logical connection 507 between the computer X 106 and LU-b 120.

Through the above operations, environment of the active computer B 104 can be taken over by the standby computer X 106.

FIG. 7 is a configuration diagram showing a specific computer switchover operation of an active computer which uses a built-in disk for access to the booting OS, as an aspect of the computer switchover in the computer system according to the present embodiment.

In the computer system shown in FIG. 7, configurations designated by like reference numerals and units having like functions shown in FIG. 1 are excluded from the description.

Configuration in the connection management table 110 shown in FIG. 2A is reflected on the path table 116, whereby the active computer C 105 configures a logical connection 502 with the TPM-c 114.

When the active computer C 105 is stopped due to occurrence of a failure, the management server 101 detects the stop and refers to the column “Computer C” in the connection management table 110. Since the connection management table 110 of FIG. 2A indicates that the TPM ID is TPM-c 114 and the booting OS Disk is a built-in disk 117, the management server 101 determines that takeover of the TPM-c 114 to the standby computer X 106 is impossible, and therefore does not rewrite the connection management table 110. With a previously configured logical connection 503 with the TPM-x 115, the standby computer X 106 can take over a computer environment using the TPM.

The above embodiment provides a computer system capable of taking over a TPM in use even when a computer switchover takes place. Further, the above embodiment provides a computer system which is capable of determining according to the disk location whether or not to take over a TPM, by identifying the location of a disk used by an active computer for OS activation.

The present invention is not limited to the embodiments described above but includes various changes and modifications. For example, the above embodiments are described in detail in order that the present invention is easily understood, but the present invention is not necessarily limited to such computer systems comprising all of the configurations described above.

Further, part or whole of the above configurations, functions, processing units, processing means, or the like may be achieved, for example, with a hardware designed by using integrated circuits. Further, the above configurations, functions or the like may be achieved with a software using processors which interpret and implement programs achieving respective functions. Information of programs, tables, files or the like for achieving functions may be stored in a recording device including a memory, a hard disk, SSD (Solid State Drive) or the like, or in a recording medium including an IC card, a SD card, a DVD or the like.

Further, control lines and information lines shown herein are those considered necessary for the description, but are not necessarily all control lines and information lines. In practice, it may be considered that almost all configurations are mutually connected to one another.

what is claimed is:

1. A computer system comprising:
a plurality of computers;
a storage unit configured to store information of the plurality of computers;
a trusted platform module (hereinafter referred to as TPM) comprising encryption means configured to encrypt information of the storage units;
a TPM switch configured to connect the plurality of computers and the TPMs to one another;
connection management information configured to manage the association between the plurality of computers and the TPMs in the connection; and a management server configured to manage the plurality of computers,
wherein the management server, upon detecting that a first computer is stopped due to occurrence of a failure, rewrites an identifier of a TPM associated to a second computer to an identifier of a TPM associated to the stopped first computer, in the connection management information,
wherein the TPM switch, based on the rewritten connection management information, connects a TPM associated with the stopped first computer and the second computer to each other, and wherein the second computer, by using a TPM associated with the stopped first computer, accesses to a storage unit where a booting OS of the stopped first computer is stored, and takes over and activates the booting OS of the stopped first computer.

2. The computer system according to claim 1,
wherein the TPM switch includes upstream ports connected to the TPMs, downstream ports connected to the computers, and path information managing the connection association between the upstream ports and the downstream ports,
wherein the management server includes a switch control unit configured to rewrite the path information,
wherein the switch control unit, based on the rewritten connection management information, rewrites an identifier of an upstream port connected to a TPM associated with the second computer to an identifier of an upstream port connected to a TPM associated with the stopped first computer, in the path table, and
wherein the TPM switch, based on the rewritten path information, connects the upstream port connected to a TPM associated with the stopped first computer and a downstream port connected to the second computer to each other.

3. The computer system according to claim 2, wherein a booting OS of the stopped first computer is stored in a logical unit of an external storage device in the storage unit.

4. The computer system according to claim 2,
wherein a booting OS of the stopped first computer is stored in a built-in disk in the first computer,
wherein the TPM switch, based on the path information, connects a TPM associated with the second computer and the second computer to each other, and
wherein the management server activates the second computer connected to the TPM.

5. The computer system according to claim 3,
wherein the management server refers to the connection management information to determine whether there exists a TPM associated with the first computer, and
wherein when there exists no TPM associated with the first computer, the second computer accesses to the logical unit wherein a booting OS of the stopped first computer is stored, and takes over and activates the booting OS of the stopped first computer.

6. The computer system according to claim 4, wherein the connection management information manages the association among an identifier of the computer, an identifier of a TPM associated with the computer, and an identifier of the storage unit wherein a booting OS of the computer is stored.

7. The computer system according to claim 5, wherein the connection management information manages the association among an identifier of the computer, an identifier of a TPM associated with the computer, and an identifier of the storage unit wherein a booting OS of the computer is stored.

8. The computer system according to claim 7, further comprising:
a fiber channel switch configured to connect the computer and the external storage device to each other,
wherein the fiber channel switch includes a connection port connected to the computer and having a unique ID allocated thereto,
wherein the second computer rewrites a unique ID allocated to a connection port connected to the second computer to a unique ID allocated to a connection port connected to the stopped first computer, and
wherein the second computer, by using the rewritten unique ID, accesses to the logical unit wherein a booting OS of the stopped first computer is stored.

9. The computer system according to claim 8, wherein a unique ID allocated to a connection port in the fiber channel is the World Wide Name.

10. The computer system according to claim 8, wherein the management server distributes a program thereof to the second computer, and the second computer executes the distributed program to take over information of the stopped first computer.

11. A method for taking over a module in a computer system including a plurality of computers, a storage unit configured to store information of the plurality of computers, and a management server configured to manage the computers,
wherein the plurality of computers and trusted platform modules (hereinafter referred to as TPMs) are connected to one another via a TPM switch,
wherein connection management information manages the association between the plurality of computers and the TPMs in the connection,
wherein the management server, upon detecting that a first computer is stopped due to occurrence of a failure, rewrites, in the connection management information, an identifier of a TPM associated with a second computer to an identifier of a TPM associated with the stopped first computer,
wherein the TPM switch, based on the rewritten connection management information, connects the TPM associated with the stopped first computer and the second computer to each other, and
wherein the second computer, by using the TPM associated with the stopped first computer, accesses to a storage unit where a booting OS of the stopped first computer is stored, and takes over and activates the booting OS of the stopped first computer.

12. The method for taking over a module according to claim 11,
wherein the TPM switch includes upstream ports connected to the TPMs, downstream ports connected to the plurality of computers, and path information managing the connection association between the upstream ports and the downstream ports,
wherein the management server includes a switch control unit configured to rewrite the path information,
wherein the switch control unit, based on the rewritten connection management information, rewrites, in the path information, an identifier of an upstream port connected to a TPM associated with the second computer to an identifier of an upstream port connected to a TPM associated with the stopped first computer, and
wherein the TPM switch, based on the rewritten path information, connects the upstream port connected to a TPM associated with the stopped first computer and a downstream port connected to the second computer to each other.

13. The method for taking over a module according to claim 12, wherein, when a booting OS of the stopped first computer is stored in a logical unit of an external storage device included in the storage unit, the second computer accesses to the logical unit wherein the booting OS of the stopped first computer is stored.

14. The method for taking over a module according to claim 12, wherein when a booting OS of the stopped first computer is stored in a built-in disk included in the first computer, the TPM switch, based on the path information, connects a TPM associated to the second computer and the second computer to each other; and the management server activates the second computer connected to the TPM.

15. The method for taking over a module according to claim 13, wherein the management server refers to the connection management information to determine whether or not there exists a TPM associated with the first computer; and when there exists no TPM associated with the first computer, the second computer accesses to the logical unit wherein a booting OS of the stopped first computer is stored, and takes over and activates the booting OS of the stopped first computer.
